(19) United States
(12) Patent Application Publication
(10) Pub. No.: US 2014/0210194 A1
(43) Pub. Date: Jul. 31, 2014

(54) INFLATOR WITH SHAPED CHARGE INITIATOR

(71) Applicant: TRW VEHICLE SAFETY SYSTEMS INC., Washington, MI (US)

(72) Inventor: Harold O. Horn, Gilbert, AZ (US)

(73) Assignee: TRW Vehicle Safety Systems Inc., Washington, MI (US)

(21) Appl. No.: 13/749,751

(22) Filed: Jan. 25, 2013

(51) Int. Cl. B60R 21/274

(52) U.S. Cl. CPC B60R 21/274
USPC 280/737

(57) ABSTRACT

An inflator (40, 40a) for inflating an inflatable vehicle occupant protection device (14) includes structure that defines a chamber (120, 120a) and an initiator (200) comprising a shaped charge that is actuatable to rupture the structure to open the chamber.

### TECHNICAL FIELD

The invention relates to an inflator for providing inflation fluid for inflating an inflatable vehicle occupant protection device.

### BACKGROUND OF THE INVENTION

It is known to provide an inflator for inflating an inflatable vehicle occupant protection device. One particular type of inflator is a stored gas inflator in which a volume of inflation fluid in the form of a non-combustible gas or mixture of gasses is stored under pressure in a gas storage chamber. A rupturable closure member seals the stored gas in the chamber. The stored gas inflator is actuatable to rupture the closure member to release the stored inflation fluid to be discharged through an inflator outlet.

In the art of inflators for inflating inflatable vehicle occupant protection devices, the inflator must be capable of providing the requisite volume of inflation fluid to the protection device within a required amount of time after the occurrence of the event for which occupant protection is necessary. Since these requirements often involve providing a comparatively large volume of inflation fluid in a comparatively short period of time, the inflator must operate in a predictable, reliable, and repeatable manner. Given the fact that the inflator must maintain these characteristics over a term dormancy that spans many years, a great deal of engineering is necessary to ensure that the various inflator components maintain their operability despite what can potentially be a very long period of inactivity.

For example, to ensure that the closure member ruptures completely, efficiently, and in a repeatable and reliable manner, many conventional inflators utilize disks that are constructed of costly alloys and are manufactured under strict tolerances. Many such closure members employ the use of high precision score lines, which adds to the cost of manufacturing the disks. This combination of costly materials and strict tolerances yields an undesirably high cost. Additionally, the use of score lines to boost predictability and reliable opening can also result in fragmenting of the closure member, which necessitates the use of filters that further increase the overall cost of the inflator.

### SUMMARY OF THE INVENTION

In one aspect, the invention relates to an inflator for inflating an inflatable vehicle occupant protection device. The inflator includes structure that defines a chamber and an initiator. The initiator includes a shaped charge that is actuatable to rupture the structure to open the chamber.

In another aspect, the invention also relates to an initiator that is actuatable to cause the release of inflation fluid from a stored gas inflator. The initiator includes a shaped charge that is actuatable to rupture structure of the inflator that defines a chamber for storing inflation fluid.

### BRIEF DESCRIPTION OF THE DRAWINGS

The foregoing and other features of the invention will become apparent to those skilled in the art to which the invention relates upon reading the following description with reference to the accompanying drawings, in which:

FIG. 1 illustrates an apparatus for helping to protect an occupant of a vehicle, according the invention;

FIG. 2A is a sectional view illustrating an inflator of the apparatus of FIG. 1 in a non-actuated condition, according to a first embodiment of the invention;

FIG. 2B is a sectional view illustrating the inflator of FIG. 2A in an actuated condition;

FIG. 3A is a sectional view illustrating an inflator of the apparatus of FIG. 1 in a non-actuated condition, according to a second embodiment of the invention;

FIG. 3B is a sectional view illustrating the inflator of FIG. 3A in an actuated condition;

FIG. 4A is a schematic perspective view of an initiator that forms a portion of the inflators of FIGS. 2A-3B;

FIG. 4B is a schematic perspective sectional view of the initiator of FIG. 4A; and

FIGS. 5A-5C are schematic plan views illustrating the operation of the initiator of FIGS. 4A and 4B.

### DESCRIPTION OF EMBODIMENTS

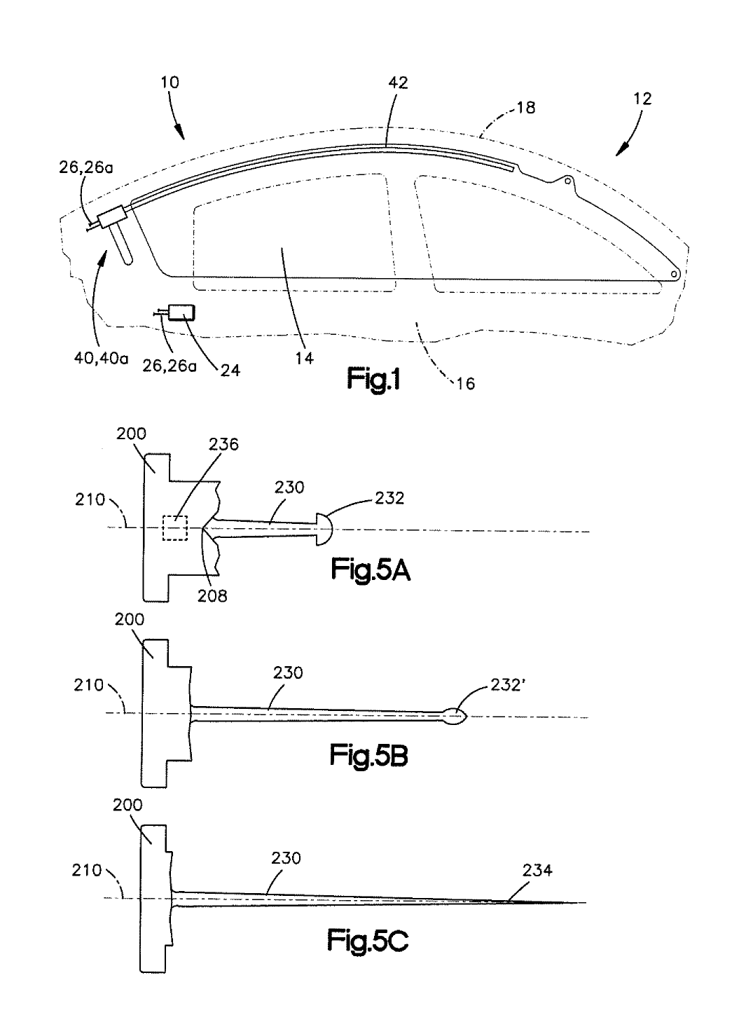

Representative of the invention, an apparatus 10 helps to protect an occupant (not shown) of a vehicle 12. In the embodiment illustrated in FIG. 1, the apparatus 10 includes an inflatable vehicle occupant protection device in the form of an inflatable curtain 14. The apparatus 10 could include an alternative type of inflatable vehicle occupant protection device, such as an inflatable air bag, an inflatable seat belt, an inflatable knee bolster, an inflatable headliner, a knee bolster operated by an inflatable air bag, or any other vehicle occupant protection device that requires inflation.

The inflatable curtain 14 has a stored position adjacent the intersection of a side structure 16 and a roof 18 of the vehicle 12. The inflatable curtain 14 is inflatable from the stored position (not shown) to the illustrated deployed position extending away from the roof 18 along the side structure 16. In the deployed position, the inflatable curtain 14 is positioned between the side structure 16 and any occupants of the vehicle 12.

The inflatable curtain 14 can be constructed of any suitable material, such as nylon (e.g., woven nylon 6-6 yarns). The inflatable curtain 14 may be uncoated, coated with a material, such as a gas impermeable urethane, or laminated with a material, such as a gas impermeable film. The inflatable curtain 14 thus may have a gas-tight or substantially gas-tight construction. Those skilled in the art will appreciate that alternative materials, such as polyester yarn, and alternatives coatings, such as silicone, may also be used to construct the inflatable curtain 14.

The apparatus 10 also includes an inflation fluid source in the form of an inflator 40. The inflator 40 is actuatable to provide inflation fluid for inflating the inflatable curtain 14. In the embodiment illustrated in FIG. 1, the inflator 40 is connected in fluid communication with the inflatable curtain 14 through a fill tube 42. Alternatively, the fill tube 42 could be omitted, in which case the inflator 40 could be connected directly to the inflatable curtain 14.

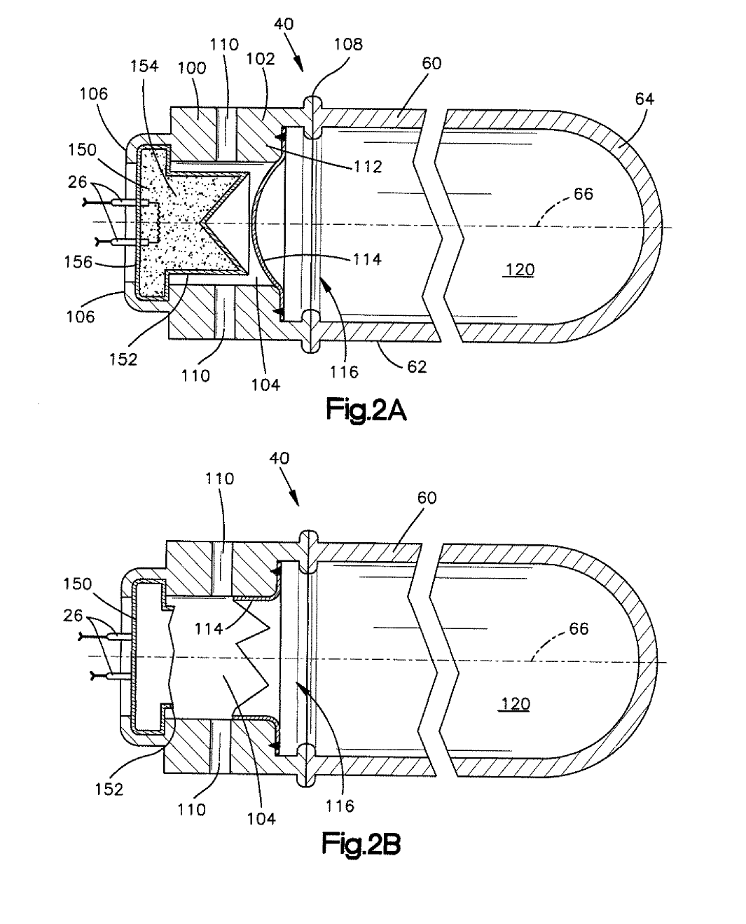

The inflator 40 may be configured in a variety of manners. An example configuration of the inflator 40 is shown in FIG. 2A. In the example of FIG. 2A, the inflator 40 includes a container portion 60 and an end cap 100. The container portion 60 has an elongated cylindrical side wall 62 and a domed end wall 64. The container portion 60 is constructed of a high strength material, such as tubular steel, aluminum, or other suitable metals or metal alloys. The side wall 62 and end wall 64 are centered on a longitudinal axis 66. The container portion 60 has a length measured along the axis 66. The length and/or diameter of the container portion 60 can be selected based on the volume of inflation fluid that the inflator 40 is to provide to the curtain 14.

The end cap 100 aligned with the container portion 60 along the axis 66 and is connected to an open end 70 of the container portion by suitable means, such as a weld joint 108. The weld joint 108 can be formed, for example, via a friction weld, butt weld, or TIG weld. The end cap 100 can be constructed of a material similar or identical to the container portion 60, e.g., steel, aluminum, or other suitable metals or metal alloys. The end cap 100 may be formed in any suitable manner, such as by machining or stamping the end cap from a single piece of material.

The end cap 100 includes a cylindrical side wall 102 that has an outside diameter about equal to that of the container portion 60. The side wall 102 defines a central discharge chamber 104 in which an initiator 150 is supported. The initiator 150 includes a cap or housing 152 that supports a body of pyrotechnic material 154. In the illustrated embodiment, retainer portions 106 of the end cap 100 are crimped or otherwise deformed to secure a flanged annular rim portion 156 of the initiator 150 to the end cap 100.

The end cap 100 also includes discharge ports 110 that extend radially through the side wall 102 and provide fluid communication between the discharge chamber 104 and the exterior of the inflator 40. The end cap 100 could have discharge ports with alternative configurations, such as ports configured to extend longitudinally through the end cap. An annular shoulder portion 112 of the end cap 100 supports a rupturable closure member 114, sometimes referred to as a rupture disk or burst disk. The closure member 114 can be secured to the shoulder portion 112, by means, such as a weld.

The structure of the closure member 114, end cap 100 and container portion 60 define an inflation fluid chamber 120 of the inflator 40. The closure member 114 spans an opening 116 that provides fluid communication between the inflation fluid chamber 120 and the discharge chamber 104.

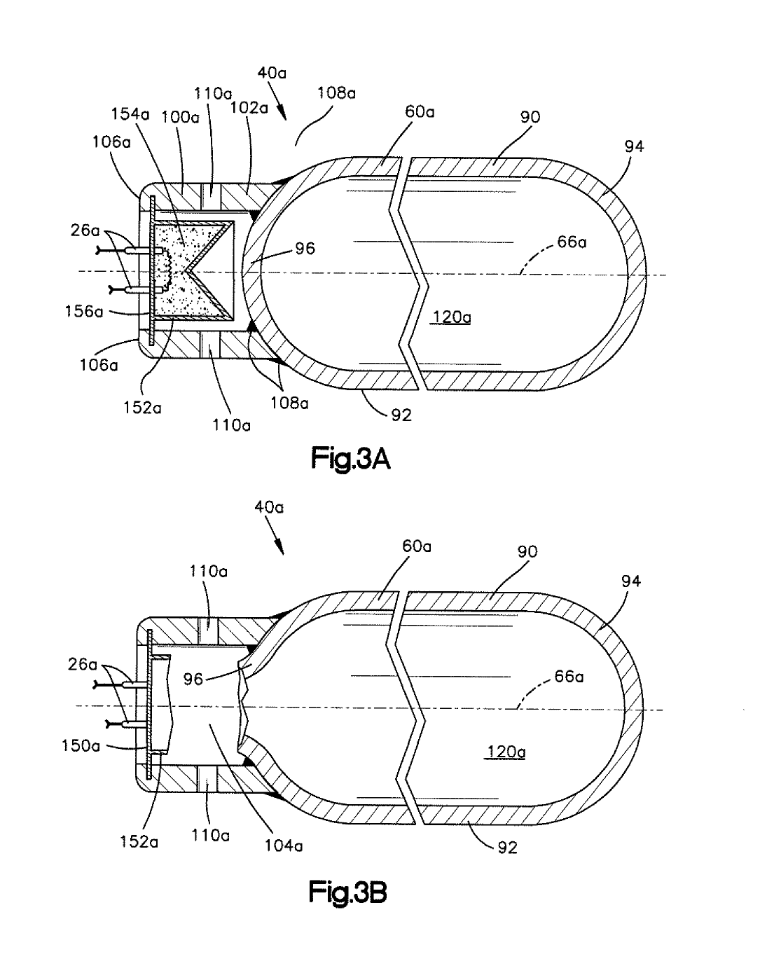

Another example configuration of the inflator is shown in FIG. 3A. In the example of FIG. 3A, numerals similar to those of FIG. 2A are used with the suffix “a” used for clarity. The inflator 40a of FIG. 3A utilizes a closed container configuration that facilitates the omission of a closure member.

Referring to FIG. 3A, the inflator 40a includes a container portion 60a and an end cap 100a. The container portion 60a is a closed container formed by a container wall 90 that has a portion defining an elongated cylindrical side wall 92, a portion defining a first domed end wall 94, and a portion defining an opposite second domed end wall 96. The structure that defines the inflation fluid chamber 120 of the inflator 40a in the embodiment of FIGS. 3A-3B is the side wall 92 and end walls 94 and 96.

The container portion 60a, i.e., the container wall 90, is constructed of a high strength material, such as tubular steel, aluminum, or other suitable metals or metal alloys. The side wall 92 and end walls 94, 96 are centered on a longitudinal axis 66a. The container portion 60a has a length measured along the axis 66a. The length and/or diameter of the container portion 60a can be selected based on the volume of inflation fluid that the inflator 40a is to provide to the curtain 14.

The end cap 100a aligned with the container portion 60a along the axis 66a and is connected to the second end wall 96 of the container portion by suitable means, such as a weld joint 108a. The weld joint 108a can be formed, for example, via a friction weld, butt weld, or TIG weld. The end cap 100a can be constructed of a material similar or identical to the container portion 60a, e.g., steel, aluminum, or other suitable metals or metal alloys. The end cap 100a may be formed in any suitable manner, such as by machining or stamping the end cap from a single piece of material.

The end cap 100a includes a cylindrical side wall 102a that has an outside diameter smaller than that of the container portion 60a. The side wall 102a defines a central discharge chamber 104a in which an initiator 150a is supported. The initiator 150a includes a cap or housing 152a that supports a body of pyrotechnic material 154a. In the illustrated embodiment, retainer portions 106a of the end cap 100a are crimped or otherwise deformed to secure a flanged annular rim portion 156a of the initiator 150a to the end cap 100a. The initiator 150a, when secured to the end cap 100a, is positioned adjacent or near the second end wall 96 of the container 60a.

The end cap 100a also includes discharge ports 110a that extend radially through the side wall 102a and provide fluid communication between the discharge chamber 104a and the exterior of the inflator 40a. Alternatively, the end cap 100a could have discharge ports that are configured differently, such as being configured to extend longitudinally through the end cap.

Referring to FIG. 1, upon sensing the occurrence of an event for which inflation of the inflatable curtain is desired, such as a side impact, a vehicle rollover, or both, a sensor 24 provides an actuation signal to the inflator 40, 40a via lead wires 26, 26a. Upon actuation, the inflator 40, 40a discharges inflation fluid that travels from the inflator through the fill tube 42 into the inflatable curtain 14. The inflatable curtain 14 inflates and deploys from the stored condition to the inflated and deployed condition shown in FIG. 1.

Referring to FIG. 2B, the lead wires 26 provide the actuation signal to the initiator 150. The initiator 150 is actuated in response to receiving the actuation signal. When the initiator 150 is actuated, the pyrotechnic material 154 (see FIG. 2A) in the initiator cap 152 ignites, and a combustion or reaction of the pyrotechnic material causes the closure member 114 to rupture.

Upon rupture of the closure member 114, the inflation fluid stored in the fluid storage chamber 120 is released to flow through the opening 116 into the discharge chamber 104 and exit the inflator 40 through the discharge ports 110. The discharged inflation fluid travels from the inflator 40 through the fill tube 42 into the inflatable curtain 14 (see FIG. 1).

Referring to FIG. 3A, the lead wires 26a provide the actuation signal to the initiator 150a. The initiator 150a is actuated in response to receiving the actuation signal. When the initiator 150a is actuated, the pyrotechnic material 154a (see FIG. 2A) in the initiator cap 152a ignites, and a combustion or reaction of the pyrotechnic material causes the second end wall 96 of the container 60a to rupture.

Upon rupture of the second end wall 96, the inflation fluid stored in the fluid storage chamber 120a is released to flow through the discharge chamber 104a and exit the inflator 40a through the discharge ports 110a. The discharged inflation fluid travels from the inflator 40a through the fill tube 42 into the inflatable curtain 14 (see FIG. 1).

According to the invention, the initiator 150, 150a implements a shaped charge that improves the predictability, reliability and repeatability of the inflator. The shaped charge of the initiator 150, 150a focuses its energy in a pattern that is predetermined by the shape of the charge. For example, the shaped charge can focus its energy along a line or axis. In doing so, the charge is very accurate and controllable, and can be utilized to ensure that the structure defining the chamber, i.e., closure member 114 or container end wall 96, is opened in the desired predictable, reliable, and repeatable manner.

According to the invention, controlling these characteristics through the shaped charge design of the initiator relieves the need to precision engineer a closure member. In the embodiment of FIGS. 2A and 2B, since the shaped charge of the initiator 150 is produces a predictable, reliable, and repeatable opening of the closure member 114, the manufacture of the disk may not require the use of costly alloys and precision manufactured score lines. In fact, as shown in the embodiment of FIGS. 3A and 3B, the shaped charge initiator 150a can be capable of rupturing the end wall 60 of the container 60a, thereby rendering unnecessary the need for any closure member at all.

A shaped charge is an explosive charge shaped to focus the effect of the explosive's energy. The shape of the charge determines the shape of the jet that results from detonation of the explosive charge. It is the focused kinetic energy of the jet that ruptures the closure member 114. The effectiveness of shaped charges is owed to what is referred to as the Monroe or Neumann effect. According to this effect, blast energy is focused due to a hollow or void cut on a surface of an explosive material.

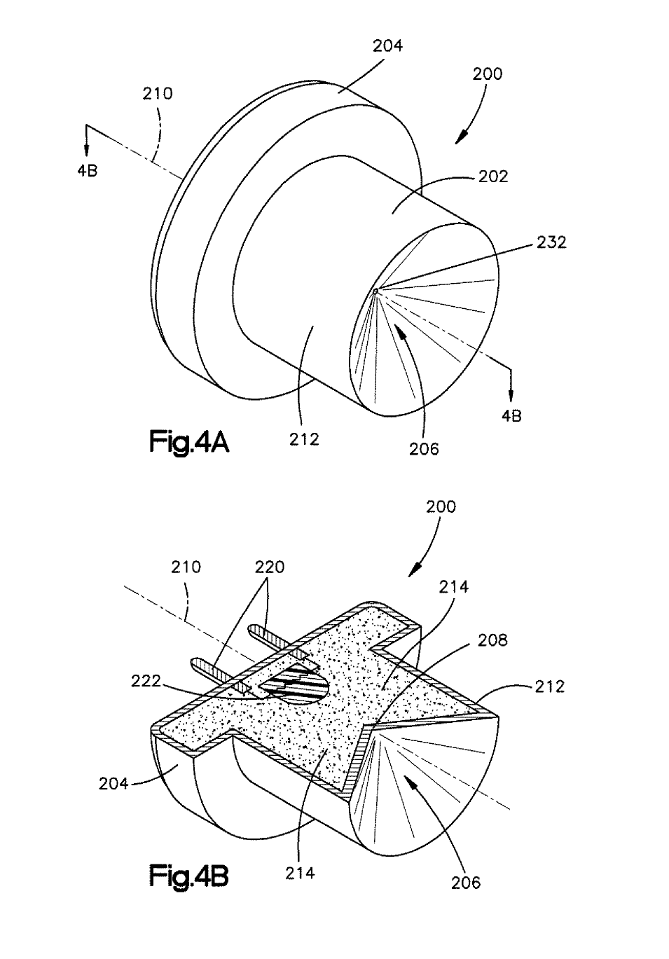

A shaped charge initiator 200 of the invention is illustrated in FIGS. 4A and 4B. The initiator 200 is representative of the initiators 150, 150a illustrated in FIGS. 2A-3B. Referring to FIGS. 4A and 4B, the initiator 200 has a generally stepped cylindrical configuration, including a cap portion 202 and the flanged annular rim portion 204 that are centered on an axis 210. The cap 202 includes a conical hollow or void 206 that extends axially into the end of the cap that faces the container 60, 60a (see FIGS. 2A and 3A, respectively) when installed in the inflator 40, 40a. The void 206 could have other geometrical shapes, as discussed below.

The initiator 200 includes a liner 212 that forms the outer layer of the cap 202. It is the shape of the liner 212 that determines the shape of the cap 202. The void 206 is thus formed in the liner during its manufacture, e.g., via stamping. Explosive material 214 fills the cap 202 and conforms to the shape of the liner 212.

The explosive material 214 can be selected from a variety of suitable explosive/pyrotechnic materials. The explosive material 214 can be chosen, for example, based on its known detonation velocity and pressure characteristics so that the required rupture characteristics are achieved in a predictable, reliable, and repeatable manner. For example, the explosive material 214 can be a zirconium-potassium perchlorate (ZPP) material, a boron-potassium nitrate (BKNO3) material, or zirconium tungsten potassium perchlorate (ZWPP) material. Other suitable explosive and/or pyrotechnic materials could also be used.

The initiator 200 can be constructed using one or more components parts that may have various configurations that do not effect the shaped charge configuration of the initiator. The configuration of the cap 202 is the primary factor that determines the shaped charge characteristics of the initiator 200. Particularly, it is the material used to form the cap 202, the explosive material 214 that fills the cap, and the geometric configuration or shape of the cap that determines the shaped charge characteristics of the initiator 200. Because of this, the initiator 200 is illustrated schematically in FIGS. 4A and 4B, while showing with particularity the shape/configuration of the cap 200 and the explosive material 214 contained therein.

The liner 212 is constructed of metal and at least partially encapsulates the explosive material 214, which follows the shape and contour of the conical void 206. The initiator 200 may include a detonator 222, such as a squib, that ignites the explosive material 214 in response to an electrical signal received via the leads 220.

Upon actuation, the detonator 222 ignites the explosive material 214, which releases explosive energy directly away from, i.e., normal to, its surface. Because of this, the conical shaping of the explosive material 216 concentrates the explosive energy in the void 206. This concentration of explosive energy generates high pressure that drives the liner 212 to collapse inward into the void 206 toward the central axis 210. The liner 212 is compressed and squeezed forward along the axis 210. The resulting collision of the collapsing metal of the liner 212 forms a high-velocity jet of metal that is directed along the axis 210, i.e., toward the closure member 114 (see FIG. 2A) or end wall 96 (see FIG. 3A).

The jet 230 formed during ignition of the explosive material 214 progresses as shown in FIGS. 5A-5C. The jet 230 forms as the liner 212 collapses due to ignition of the explosive material 214. Referring to FIG. 5A, most of the jet 230 material originates from the radially innermost part of the void 206. The apex 208 of the conical liner 212 in the void 206 forms the very front of the jet. At the apex 208, the liner 212 does not have time to be fully accelerated before it forms its part of the jet 230. This results in the forwardmost, apex-formed portion of the jet 230 being projected at a velocity that is lower than portions formed behind it. As a result, the initial parts of the jet 230 combine to form a widened tip portion 232 of the jet.

Depending on the charge configuration, the jet 230 can travel at hypersonic speeds. The jet 230 also can disperse relatively quickly. Therefore, the location of the initiator 200 relative to the closure member 114 (FIG. 2A) or end wall 96 (FIG. 3A) is important to help ensure a predictable, reliable, and repeatable opening of the container 60, 60a. If the initiator 200 is positioned too close to the closure member 114/end wall 96, there is not enough time for the jet 230 to fully develop the required rupture energy. If the initiator 200 is positioned too far from the closure member 114/end wall 96, the jet 230 can disperse and thus lack the required rupture energy.

As the jet 230 travels along the axis 210, the tip portion 232 accelerates and begins to become drawn out, its mass spreading/elongating as shown at 232′ in FIG. 5B. Referring to FIG. 5C, further travel of the jet 230 accelerates and draws out the tip portion 232 completely, resulting in a linear tip 234.

By modifying the shape and design of the liner 212, the tip velocity and the mass distribution in the jet can be tailored to achieve desired penetration/rupture performance. For example, the liner 212 can have a is conical configuration with an internal apex angle in the range of 40 to 90 degrees. Within this range, varying the apex angles yield different distributions of jet mass and velocity. Other configurations, such as hemispheres, tulips, trumpets, ellipses, and bi-conics can also be used to produce jets with different velocity and mass distributions.

The liner 212 can be constructed of various materials, including metals and glass. Dense, ductile metals such as copper produce strong penetration forces. Other materials, particularly other metals or metal alloys can also be used. For example, metals including copper, aluminum, tungsten, tantalum, lead, tin, cadmium, cobalt, magnesium, titanium, zinc, zirconium, molybdenum, beryllium, nickel, silver, and even gold and platinum, as well as alloys of one or more these metals can be used. Of course, cost can be an issue with some of these metals. Multi-layer bimetallic liner materials, such as tin-copper liners, can also be used. The properties of the material used to construct the liner 212 helps determine its effectiveness in penetrating the closure member/end wall. Generally speaking, higher ductility yields greater penetration characteristics because the resulting jet (see FIGS. 5A-5C) maintains its form for a greater duration prior to dispersion.

The shaped charge initiator 200 can include additional features that help to enhance or improve its performance. For example, a wave shaping mass (shown schematically at 236 in FIG. 5A)—typically a disc or cylindrical block of an inert material such as metal or plastic—can be inserted within the explosive material for the purpose of changing the path of the detonation wave. The effect of adding a wave shaping mass is to modify the collapse of the cone and resulting jet formation, with the intent of increasing rupture/penetration performance. The use of a wave shaping mass can also help to save space due to the fact that a shorter charge with a wave shaping mass can achieve the same performance as a longer one without. This can be important in a side curtain inflator where space in the vehicle is limited.

From the above, it will be appreciated that the shaped charge initiator of the invention helps operate the inflator in a predictable, reliable, and repeatable manner. The shaped charge initiator helps eliminate the need for highly engineered components, such as closure members constructed of costly alloys and manufactured under strict tolerances with high precision score lines. Not only can the construction of the closure member be simplified, it can even be eliminated altogether, as seen in the embodiment of FIGS. 3A-3B. Additionally, the simplified construction of the invention helps the inflator maintain its operability over a term of many years.

From the above description of the invention, those skilled in the art will perceive applications, improvements, changes and modifications to the invention. Such applications, improvements, changes and modifications within the skill of the art are intended to be covered by the appended claims.

1. An inflator for inflating an inflatable vehicle occupant protection device, the inflator comprising:
structure defining a chamber;
an initiator comprising a shaped charge having a body of explosive material that is actuatable to rupture the structure to open the chamber; and
a wave shaping mass disposed in the body of explosive material.

2. The inflator recited in claim 1, wherein the structure defining the chamber comprises a container for storing inflation fluid under pressure, and wherein the shaped charge is configured to rupture a wall of the container.

3. The inflator recited in claim 2, wherein the shaped charge is configured to rupture an end wall portion of the container wall.

4. The inflator recited in claim 2, wherein the chamber is a closed chamber, and the container wall completely encloses the chamber.

5. The inflator recited in claim 2, wherein the inflator is free from rupture disks for closing the container.

6. The inflator recited in claim 2, wherein the a liner at least partially encapsulates the explosive material.

7. The inflator recited in claim 6, wherein the shaped charge has a generally cylindrical configuration centered on an axis, the shaped charge further comprising a void that extends along the axis into an end of the shaped charge.

8. The inflator recited in claim 7, wherein the void has a conical configuration and is oriented facing toward the container wall.

9. (canceled)

10. The inflator recited in claim 1, wherein the structure defining the chamber comprises a container for storing inflation fluid under pressure and a closure member for closing the container, and wherein the shaped charge is configured to rupture the closure member.

11. The inflator recited in claim 10, wherein the closure member is free from score lines for facilitating rupture of the closure member.

12. The inflator recited in claim 10, wherein the container comprises a container wall and an opening in the container wall, the closure member spanning across and closing the opening.

13. The inflator recited in claim 10, wherein a liner at least partially encapsulates the explosive material.

14. The inflator recited in claim 13, wherein the shaped charge has a generally cylindrical configuration centered on an axis, the shaped charge further comprising a void that extends along the axis into an end of the shaped charge.

15. The inflator recited in claim 14, wherein the void has a conical configuration and is oriented facing toward the container wall.

16. An initiator that is actuatable to cause a release of inflation fluid from a stored gas inflator, the initiator comprising a shaped charge having a body of explosive material that is actuatable to rupture structure of the inflator that defines a chamber for storing inflation fluid, and a wave shaping mass disposed in the body of explosive material.
